(19) United States
(12) Patent Application Publication
(10) Pub. No.: US 2014/0273851 A1
(43) Pub. Date: Sep. 18, 2014

(54) NON-CONTACT VAD WITH AN ACCELEROMETER, ALGORITHMICALLY GROUPED MICROPHONE ARRAYS, AND MULTI-USE BLUETOOTH HANDS-FREE VISOR AND HEADSET

(71) Applicants: Thomas Alan Donaldson, Nailsworth (GB); Gordon Simmons, San Francisco, CA (US)

(72) Inventors: Thomas Alan Donaldson, Nailsworth (GB); Gordon Simmons, San Francisco, CA (US)

(73) Assignee: AliphCom, San Francisco, CA (US)

(21) Appl. No.: 14/192,432

(22) Filed: Feb. 27, 2014

Related U.S. Application Data
(60) Provisional application No. 61/801,548, filed on Mar. 15, 2013.

(51) Int. Cl. H04M 1/60; H04M 1/62; H04W 4/00

(52) U.S. Cl. CPC H04M 1/6066; H04W 4/008; H04M 1/62
USPC 455/41.2

(57) ABSTRACT

Electronic hardware, software, wired and/or wireless network communications, Bluetooth systems, RF systems, self-powered wireless devices, signal processing, audio transducers, accelerometers, and consumer electronic (CE) devices for a wireless portable headset and a portable wireless speaker phone that the wireless portable headset docks with and communicates with are disclosed. The headset and speaker phone may wirelessly communicate with each other (e.g., Bluetooth radios or other) when docked, un-docked, or both. When docked, an internal rechargeable power source in the speaker phone may recharge another internal rechargeable power source in the headset (e.g., rechargeable Lithium-Ion type batteries). A USB connector or the like may be used to electrically communicate power between the internal rechargeable power sources and may communicate other signals, such as signals from one or more microphones to form a microphone array (e.g., when docked). Magnet(s) may be used to facilitate/retain docking of the headset with the speaker phone.

### CROSS-REFERENCE TO RELATED APPLICATIONS

This application Claims Benefit of Priority under 35 U.S.C. §119(e) to U.S. Provisional Patent Application serial number 61/801,548, filed on Mar. 15, 2013, having attorney docket number ALI-134P, and titled “Non-Contact VAD with an Accelerometer, Algorithmically Grouped Microphone Arrays, and Multi-use BT Hands-Free Visor and Headset”, which is hereby incorporated by reference in its entirety for all purposes.

### FIELD

Embodiments of the present application relate generally to electrical and electronic hardware, computer software, wired and wireless network communications, Bluetooth systems, RF systems, self-powered wireless devices, portable wireless devices, signal processing, audio transducers, accelerometers, and consumer electronic (CE) devices.

### BRIEF DESCRIPTION OF THE DRAWINGS

FIG. 1 depicts an exemplary block diagram of a wireless portable headset;

FIG. 2 depicts examples of a wireless portable headset;

FIG. 3 depicts examples for an exemplary display positioned on an exemplary portable wireless speaker phone;

FIG. 4 depicts an example of USB connectors used for a first exemplary and a second exemplary charging structure;

FIG. 5 depicts example use scenarios for an exemplary wireless portable headset and an exemplary portable wireless speaker phone;

FIG. 6 depicts an exemplary block diagram for an exemplary speaker phone;

FIG. 7 depicts an example of non-contact voice activity detection; and

FIG. 8 depicts an exemplary block diagram where a microphone array including at least two spaced apart microphones generates signals based on speech and environmental sounds that are electrically coupled with a signal processor included in an exemplary headset.

### DETAILED DESCRIPTION

Various embodiments or examples may be implemented in numerous ways, including as a system, a process, a method, an apparatus, a user interface, or a series of executable program instructions included on a non-transitory computer readable medium. Such as a non-transitory computer readable medium or a computer network where the program instructions are sent over optical, electronic, or wireless communication links and stored or otherwise fixed in a non-transitory computer readable medium. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

Hands-Free Wireless Speaker Phone with Dock for a Wireless Headset

FIG. 1 depicts a block diagram 100 of a wireless portable headset 110 and a portable wireless speaker phone 150. Wireless portable headset 110 includes a first microphone 112, a first speaker 113, a first internal rechargeable power source 114, a first charging structure 115 electrically coupled 116 with the first internal rechargeable power source 114, and a first radio (e.g., RF) transceiver 118. Optionally, wireless portable headset 110 may include additional microphones such as third microphone 120 or an array of microphones. Wireless portable headset 110 may be worn on an ear of a user (see FIG. 7).

Portable wireless speaker phone 150 includes a second internal rechargeable power source 152, a second speaker 153, a second microphone 154, a second radio (e.g., RF) transceiver 156, an integrated structure 155 for receiving the wireless portable headset 110, and a second charging structure 157 electrically coupled 158 with the second internal rechargeable power source 152. Optionally, portable wireless speaker phone 150 may include additional microphones such as a fourth microphone 159 or an array of microphones. Optionally, portable wireless speaker phone 150 may include a photovoltaic device 160 (e.g., a solar cell) electrically coupled 161 with the second internal rechargeable power source 152 and operative to charge the second internal rechargeable power source 152 from incident light radiation (not shown).

A shape of the wireless portable headset 110 and the integrated structure 155 may be configured for secure but easy insertion and removal of the wireless portable headset 110 from the portable wireless speaker phone 150. Integrated structure 155 may be a slot, channel, cut-out, groove, hole, portal, dock, or the like configured to receive the wireless portable headset 110 (e.g., to serve as a dock for the headset 110).

Headset and Speaker Phone Docked

FIG. 2 depicts examples 200 of the wireless portable headset 110 positioned (e.g., docked) in the integrated structure 155 of the portable wireless speaker phone 150. In the docked position, the first and second charging structures 115 and 157 (e.g., female and male USB connecters) are mated (e.g., connected with each other) to each other such that an electrical connection is made between the first and second internal rechargeable power source 114 and 152 (e.g., via 116 and 158). When first integrated structure is mated with second integrated structure 157, electrical connections 116 and 158 are electrically coupled with each other and second internal rechargeable power source 152 may charge first internal rechargeable power source 114. Optionally, one or both of the wireless portable headset 110 and/or the portable wireless speaker phone 150 may include a magnetic structure m1 and m2 (e.g., magnets) operative to securely hold and position the wireless portable headset 110 in the integrated structure 155, while allowing for easy removal of the wireless portable headset 110 from the integrated structure 155. Optional magnetic structures m1 and m2 may hold the wireless portable headset 110 in integrated structure 155 when docked and electrical connections 116 and 158 electrically couple with each other when the wireless portable headset 110 is docked in the portable wireless speaker phone 150 via the integrated structure 155.

FIG. 3 depicts examples 300 for a display 325 positioned on the portable wireless speaker phone 150. Display 325 may display a variety of different types of information such as caller ID, images (e.g., of a caller), charge state of one or both power sources (114 and/or 152), Bluetooth (BT) pairing status or other BT information, for example. BT pairing status may be between the headset 110 and speaker phone 150 or between speaker phone 150 and some other BT device, such as a smartphone or cell phone, for example. Display 325 may display various types of information via light emitting diode (LED) display or other type of display.

FIG. 4 depicts an example 400 of USB connectors used for the first and second charging structures 115 and 157, where one of those structures is male (e.g., 157) and the other is female (e.g., 114), or vice-versa. Docking of 110 in 155 is operative to make an electrical connection (116, 158) between power sources 114 and 152. Other signals, such as those from any of the microphones may be electrically communicated between the systems of 110 and 150, for example, to form a microphone array from any combination of 112, 120, 154, and 159. USB connectors such as micro USB or mini USB may be used for 115 and 157, for example. As one example, other signals, such as from first microphone 112, third microphone 120, second microphone 154, and fourth microphone 159 may be electrically coupled through first and second charging structures 115 and 157.

FIG. 5 depicts example use scenarios 500 for 110 and 150, such as when 110 is docked in 150. Speaker phone 150 may be configured for mounting in a vehicle, such as an automobile (e.g., on a visor 505) or positioned on a surface 525 such as a table, counter, or the like. Speaker phone 150 may be used as a mobile speaker phone and/or a conference phone. One or more of the microphones in 110 and/or 150 may be used for conference call, speaker phone calls, or mobile calls.

FIG. 6 depicts one example 600 of a block diagram for speaker phone 150, but some of the same blocks may be present in headset 110 as well. FIG. 6 includes for example: one or more processors 610, such as one or more CPU's, DSP's, μP or μC; a RF transceiver 605, such as a BT radio, and associated antenna(s) 606; an audio system 615 electrically coupled with one or more speakers 640 and one or more microphones 630 denoted as M1, M2 - . . . Mn; executable code 620 in a non-transitory computer readable medium (e.g., for signal processing algorithms, boot code, operating system, etc.); circuitry 645 for processing signals; and a power system 670 electrically coupled with a rechargeable power source 675 and a charging port 671 (e.g., for 115, 157) for supplying electrical power for the system and/or charging 675 (e.g., 114, 152).

Audio system 615 may be electrically coupled with and may form a microphone array from microphones in 110, 150, or both via the RF transceiver 605 or through a hard wired connection via the charging structures 115 and 157.

Processor 610, circuitry 645, and executable code 620 may be used in any combination to processes signals from any of the microphones to form microphone arrays, virtual microphones, dual omni-directional microphone arrays (DOMA), voice activity detection (VDA), noise suppression, noise cancellation, or other signal processing algorithms as required.

Non-Contact Voice Activity Detection

When a BT headset user is speaking in a noisy environment, it can be difficult to separate their speech from background noise. At least two microphones in a directional array configuration, an accelerometer, and signal processing using hardware (e.g., a DSP) in conjunction with software (e.g., signal processing algorithms) may be used for correlating accelerometer movement (e.g., from a user head) with outputs from the microphone array. The signal processing may be used to separate parts of the outputs from the microphone array that is well correlated with the accelerometer movement with those parts that are not well correlated with the accelerometer movement. The signal processing may be further used to attenuate microphone signals from the array that are well correlated with the accelerometer movement and strengthening (e.g., boosting or amplifying) microphone signals from the array that are not well correlated with the accelerometer movement.

Assume for purposes of explanation that an accelerometer is mounted to a headset (e.g., a BT headset) worn by a user (e.g., on the users head or ear(s)). Furthermore, assume the user is moving his/her head while speaking. Sound from the user's mouth will continue to arrive in the same direction relative to microphones that are carried by the headset. However, sound sources in the environment around the user will move relative to the user's head and therefore relative to the microphones. The accelerometer detects the movement of the user's head and generates signals indicative of that movement. Therefore, the sound sources in the environment around the user (e.g., noise) will be well correlated with the accelerometer motion, while signals representative of the user's speech will be poorly correlated with the accelerometer motion.

FIG. 7 depicts one example 700 of the scenario described above. In FIG. 7, a user 750 has a headset 710 (e.g., a BT headset) mounted to one of his/her ears, for example. Headset 710 includes at least two spaced apart microphones (706, 708), at least one accelerometer 715, and a speaker 725, and other components not shown, such as signal processing hardware and software, for example. The user 750 is in an environment 770 that includes sounds 731, 735, and 733, all of which may come from different directions relative to the headset 710. User 750 is also speaking and generating sound 780 from his/her speech. Motion 720 of a head 701 of user 750 changes a positional relationship between microphones 706 and 708 relative to sounds 731-735, but not to speech 780, and also causes accelerometer 715 to generate signals indicative of the motion 720. Furthermore, microphones 706 and 708 also generate signals from the speech 780 and the sounds 731-735. Signal processing hardware, circuitry, and algorithms in headset 710 may be applied as described above to manipulate the signals from microphones 706 and 708 based on their correlation or lack thereof with the signals from the accelerometer 715 to process the speech for making the speech more intelligible and/or driving speaker 725 to make it easier for user 750 the hear a conversation on the headset 710. A signal processor in headset 710 may receive signals from the accelerometer 715, a first microphone (e.g., MIC1 706) and a second microphone (e.g., MIC2 708), and process those signals to make speech more intelligible and/or to drive speaker 725 to make it easier for the user 750 to hear conversation, for example.

FIG. 8 depicts a top level block diagram 800 where a microphone array 850 including at least two spaced apart microphones 706 . . . 708 generates signals 801 based on speech 780 and environmental 770 sounds 890 that are electrically coupled with a signal processor 810 included in headset 710. Accelerometer 715 generates motion signals 803 that are electrically coupled with the signal processor 810 caused by head motion 720.

Signal processor 810 may include one or more CPU's 820 (e.g., a DSP and/or μP or μC), code 815 may include algorithms fixed in a non-transitory computer readable medium (e.g., Flash memory or other) for processing the signals (801, 803) and circuitry 830 (CKT) which may be used in conjunction with the CPU 820 and code 815 for signal conditioning, amplifying, boosting signals, attenuating signals, and driving 805 speaker 725, etc. The correlating, attenuating, and strengthening described above may be accomplished using one or more of the blocks in signal processor 810. Signal processor 810 may be an application specific integrated circuit (ASIC), FPGA, gate array, or the like.

The above described signal processing does not utilize any sensor/signal information from the accelerometer 715 or microphone array 850 due to vibrations from the user's 750 body, jaw, skin or the like. Therefore, none of the signals 801 and 803 are generated by energy or vibrations caused by contact between the headset 710 and user 750 or any portion of user's head 701.

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

What is claimed is:

1. A wireless system, comprising:
a wireless portable headset operative to be worn on a body of a user and including a first microphone, a first speaker, a first internal rechargeable power source, a first charging structure electrically coupled with the first internal rechargeable power source, and a first radio transceiver;
a portable wireless speaker phone having a second internal rechargeable power source, a second speaker, a second microphone, a second radio transceiver, an integrated structure for receiving the wireless portable headset, and a second charging structure electrically coupled with the second internal rechargeable power source,
the first and second charging structures operative to electrically couple the first and second internal rechargeable power sources with each other when the wireless portable headset is positioned in the integrated structure, wherein electrical power from the second internal rechargeable power source charges the first internal rechargeable power source when the wireless portable headset is positioned in the integrated structure.

2. The wireless system of claim 1 and further comprising:
at least one display positioned on the portable wireless speaker phone and operative to display status information on the portable wireless speaker phone, the wireless portable headset, or both.

3. The wireless system of claim 2, wherein the at least one display is operative to display status information on a charge state of the first internal rechargeable power source when the wireless portable headset is docked in the portable wireless speaker phone.

4. The wireless system of claim 2, wherein the at least one display is operative to display status information on a charge state of the second internal rechargeable power source.

5. The wireless system of claim 4, wherein the status information on the charge state of the second internal rechargeable power source is displayed when the wireless portable headset is docked in the portable wireless speaker phone.

6. The wireless system of claim 2, wherein the at least one display is operative to display Bluetooth (BT) pairing status of the wireless portable headset, the portable wireless speaker phone, or both.

7. The wireless system of claim 1, wherein the first and second charging structures comprise USB connectors.

8. The wireless system of claim 1, wherein the first and second radio transceivers comprise Bluetooth (BT) radio transceivers.

9. The wireless system of claim 8, wherein the portable wireless speaker phone and the wireless portable headset are BT paired with each other when the wireless portable headset and the portable wireless speaker phone are docked with each other, are not docked with each other, or both.

10. The wireless system of claim 1, wherein when the wireless portable headset is positioned in the integrated structure, the first microphone is in communication with signal processing circuitry in the portable wireless speaker phone, the signal processing circuitry and signal processing algorithms executed by the signal processing circuitry are operative to process audio signals from both the first and second microphones.

11. The wireless system of claim 10, wherein the first and second microphones are operative as a microphone array having a plurality of microphones, when the wireless portable headset is positioned in the integrated structure.

12. The wireless system of claim 10, wherein the first and second microphones are operative as dual omni-directional microphone array (DOMA) having a plurality of microphones, when the wireless portable headset is positioned in the integrated structure.

13. The wireless system of claim 10 and further comprising:
a non-transitory computer readable medium including executable program instructions for the signal processing algorithms; and
a digital signal processor (DSP) included in the signal processing circuitry and operative to execute at least a portion of the executable program instructions.

14. The wireless system of claim 10, wherein the signal processing algorithms include a voice activity detection (VAD) algorithm.

15. The wireless system of claim 10, wherein the signal processing algorithms include a selected one or more of a noise suppression algorithm or a noise cancellation algorithm.

16. The wireless system of claim 1 and further comprising:
a magnetic structure positioned on the portable wireless speaker phone, the wireless portable headset, or both and operative to apply a magnetic force operative to retain the wireless portable headset in the integrated structure.

17. The wireless system of claim 1 and further comprising:
a photovoltaic device positioned on the portable wireless speaker phone and electrically coupled with the second internal rechargeable power source and operative to charge the second internal rechargeable power source using light radiation incident on the photovoltaic device.

18. A method for non-contact voice activity detection, comprising:
receiving sound signals generated by sound incident on at least two spaced apart microphones, the sound signals including signals generated by a user's speech and by sound from an environment the user is positioned in;
receiving motion signals from at least one accelerometer that are derived solely by motion of the users head in the environment;
processing the sound and motion signals in a signal processor;
correlating the motion signals with the sound signals;
separating portions of the sound signals that are well correlated with the motion signals from other portions of the sound signals that are not well correlated with the motion signals;
attenuating the portions that are well correlated; and
strengthening the other portions that are not well correlated.

19. The method of claim 18, wherein a selected one or more of the correlating, the separating, the strengthening, or the attenuating occur in the signal processor.

20. The method of claim 18 and further comprising:
driving a signal on a speaker as a result of a selected one or more the correlating, the separating, the strengthening, or the attenuating.
